(19) United States
(12) Patent Application Publication
(10) Pub. No.: US 2026/0329326 A1
(43) Pub. Date: Oct. 22, 2026

(54) KNOB ASSEMBLY FOR HOUSEHOLD APPLIANCE

(71) Applicant: WHIRLPOOL CORPORATION, BENTON HARBOR, MI (US)

(72) Inventors: VASANTI D. KAHANE, NASHIK (IN); PRAVIN A. SHINDE, PUNE (IN)

(21) Appl. No.: 19/181,902

(22) Filed: Apr. 17, 2025

(51) Int. Cl. G05G 1/12

(52) U.S. Cl. CPC G05G 1/12

(57) ABSTRACT

A knob assembly for a household appliance includes a control panel and a control rod, the knob assembly further includes a knob having a body section, a blade section, and a stem. The knob includes an exterior surface and an interior surface with the interior surface at least partially defining an interior extending through at least a portion of the body section and at least a portion of the blade section. A body is received within at least a portion of the interior. A spring is received within the stem. A bezel is configured to be operably coupled to a to the control panel and surrounding the control rod of the household appliance. The knob and spring are operably coupled to the control rod.

### TECHNICAL FIELD

The disclosure relates to a household appliance, more specifically a knob assembly for a cooktop.

### BACKGROUND

Household appliances such as stoves and ovens with heating elements typically include a knob assembly for controlling heat levels of the heating elements.

### BRIEF SUMMARY

In one aspect, the disclosure relates to a knob assembly for a household appliance having a control panel and a control rod, the knob assembly comprising: a knob having a body section, a blade section, and a stem, and wherein the knob includes an exterior surface and an interior surface with the interior surface at least partially defining an interior extending through at least a portion of the body section and at least a portion of the blade section, a body received within at least a portion of the interior, a spring received within the stem, and a bezel configured to be operably coupled to the control panel and surrounding the control rod of the household appliance, wherein the knob and spring are operably coupled to the control rod.

### BRIEF DESCRIPTION OF THE DRAWINGS

In the drawings:

FIG. 1 is a perspective view of an exemplary cooking appliance with at least one knob assembly in accordance with the present disclosure.

FIG. 2 is an exploded side perspective view of the knob assembly of FIG. 1 in accordance with various aspects of the present disclosure.

FIG. 3 is an exploded rear perspective view of the knob assembly of FIG. 1 in accordance with various aspects of the present disclosure.

FIG. 4 is a side view of the knob assembly of FIG. 1 in accordance with various aspects of the present disclosure.

FIG. 5 is a cross-sectional view of the knob assembly along line V-V of FIG. 4 in accordance with various aspects of the present disclosure.

FIG. 6 is a cross-sectional view of the knob assembly along line VI-VI of FIG. 4 in accordance with various aspects of the present disclosure.

### DETAILED DESCRIPTION

It is contemplated that a household appliance, such as a gas cooktop, can include one or more knob assemblies for controlling the heat level of heating elements such as stove burners. It will be understood that knobs of the knob assemblies are frequently adjusted or maneuvered by a user during a cycle of operation of cooking. In certain cases, when using the knob assembly, knobs with a small blade to body ratio can cause discomfort for the user and reduces the precision in which the knob is rotated. Thus, it would be beneficial to have a knob assembly with a knob having a greater blade to body ratio to improve the ergonomics of the knob and overall aesthetics of the knob assembly.

As used herein, the term “set” or “a set” of elements can be any non-zero number of elements, including only one. The exemplary drawings are for purposes of illustration only and the dimensions, positions, order and relative sizes reflected in the drawings attached hereto can vary.

Additionally, as used herein, a “controller”, or “controller module” can include a component configured or adapted to provide instruction, control, operation, or any form of communication for operable components to affect the operation thereof. A processor or controller module can include any known processor, microcontroller, or logic device, including, but not limited to: Field Programmable Gate Arrays (FPGA), an Application Specific Integrated circuit (ASIC), a Proportional controller (P), a Proportional Integral controller (PI), a Proportional Derivative controller (PD), a Proportional Integral Derivative controller (PID controller), a hardware-accelerated logic controller (e.g. for encoding, decoding, transcoding, etc.), the like, or a combination thereof. Non-limiting examples of a controller module can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types. In another non-limiting example, a processor or controller module can also include a data storage component accessible by the processor, including memory, whether transient, volatile or non-transient, or non-volatile memory.

Additional non-limiting examples of the memory can include Random Access Memory (RAM), Read-Only Memory (ROM), flash memory, or one or more different types of portable electronic memory, such as discs, DVDs, CD-ROMs, flash drives, universal serial bus (USB) drives, the like, or any suitable combination of these types of memory. In one example, the program code can be stored within the memory in a machine-readable format accessible by the processor. Additionally, the memory can store various data, data types, sensed or measured data values, inputs, generated or processed data, or the like, accessible by the processor in providing instruction, control, or operation to affect a functional or operable outcome, as described herein. In another non-limiting example, a control module can include comparing a first value with a second value and operating or controlling operations of additional components based on the satisfying of that comparison. For example, when a sensed, measured, or provided value is compared with another value, including a stored or predetermined value, the satisfaction of that comparison can result in actions, functions, or operations controllable by the controller module.

In describing aspects illustrated in the drawings, specific terminology will be resorted to for the sake of clarity. However, it is not intended that the aspects be limited to the specific terms so selected and it is to be understood that each specific term includes all technical equivalents that operate in a similar manner to accomplish a similar purpose. For example, the words “connected,” “attached,” “coupled,” and “supported” and variations thereof herein are used broadly and encompass direct and indirect connections, attachments, couplings, and supports. In addition, the terms “connected,” “coupled,” etc. and variations thereof are not restricted to physical or mechanical connections, couplings, etc. as all such types of connections should be recognized as being equivalent by those skilled in the art.

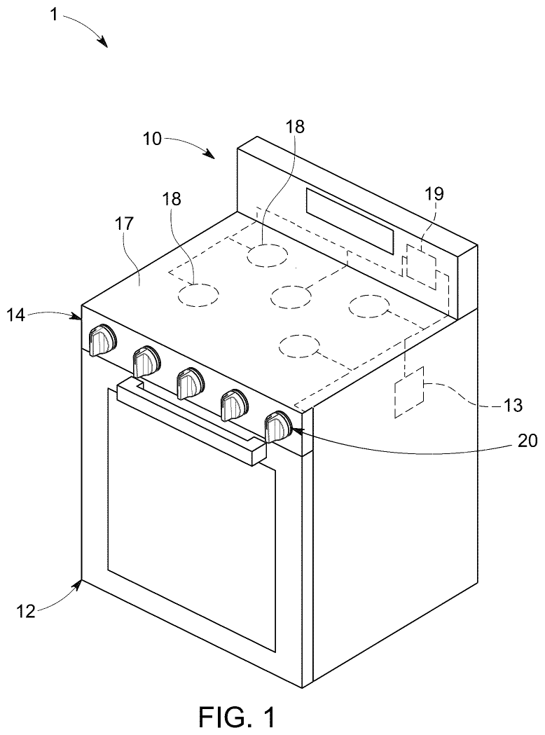

FIG. 1 illustrates an exemplary household appliance 1 in the form of a cooktop 10, which can be used for cooking one or more food items. The cooktop 10 includes a chassis or cabinet 12. An interior housing can be included and may at least partially define a cooking chamber (not shown) having an access opening (not shown) closed by a closure member such as a door.

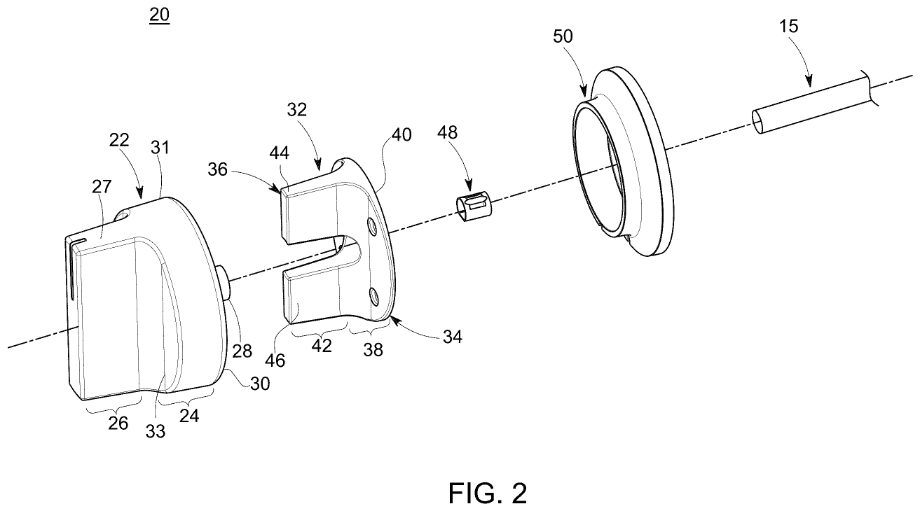

A control panel 14 includes a control rod 15 (FIG. 2). The control rod 15 is operably rotated by a knob assembly 20 for controlling a plurality of burners 18 provided on the cooktop 10. The burners 18 extend through a cooktop surface 17. The plurality of burners 18 can be any suitable burners including gas, electric, etc. By way of non-limiting illustrative example, electric heating elements provide the heat used to cook food by the cooktop 10. While five knob assemblies 20 are shown, it is contemplated that the cooktop 10 can have any number of knob assemblies. Further yet, while the knob assemblies 20 are not shown as being coupled to the burners 18 this will be understood and such connections have not been shown for the sake of clarity. An energy source or power source 13 is also provided and operably coupled to the burners 18. The power source 13 can be any suitable source of energy for generating heat, such as a gas source, electric heat element, or the like. While the power source 13 is not shown as being coupled to the burners 18 this will be understood and such connections have not been shown for the sake of clarity. While four burners 18 are shown, it is contemplated that the cooktop 10 can have any number of burners.

A controller 19 can be provided and communicatively coupled to components of the cooktop 10, including the control panel 14, the power source 13, or the burners 18. The controller 19 can be, for example, a proportional-integral-derivative (PID) controller or any other suitable controller. The controller 19 can store data (e.g., in a memory), such as default cooking parameters, user-input cooking parameters, programs for the automated cooking cycles, or the like. The controller 19 can also send output to the control panel 14 or receive input from the control panel 14, such as for displaying a status of the cooktop 10 or otherwise communicating with a user. It will be understood that the knob assembly 20 can be utilized in any suitable appliance or cooktop and that the appliance 1 and cooktop 10 are merely shown and described as one example of a suitable environment for the knob assembly 20.

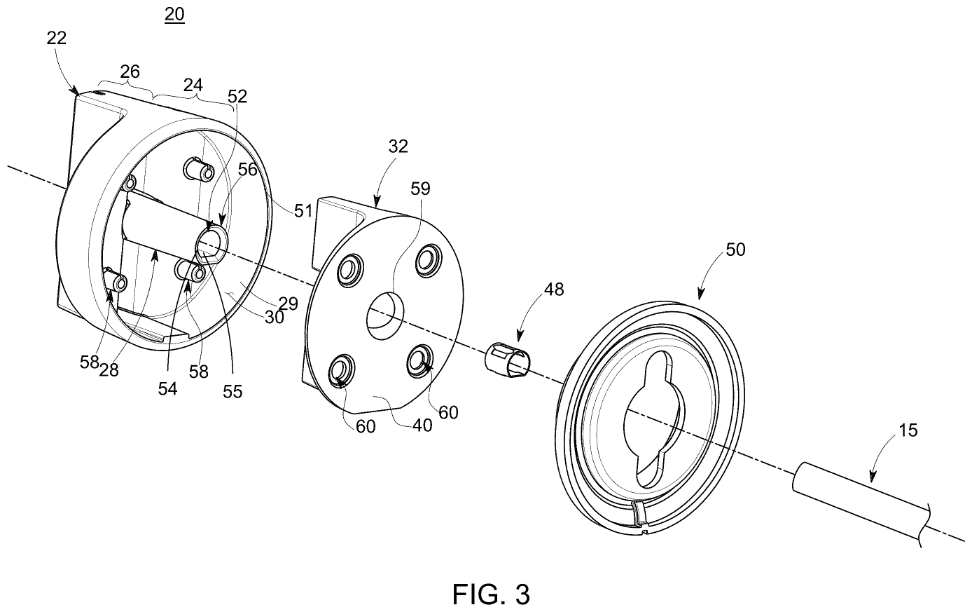

FIG. 2 shows the knob assembly 20 of FIG. 1 in an exploded view. The knob assembly 20 has a knob 22 having a body section 24, a blade section 26, and a stem 28. An exterior surface 27 and an interior surface 29 (FIG. 3) define the knob 22. An interior 30 (FIG. 3) is at least partially defined by the interior surface 29 (FIG. 3). The interior 30 (FIG. 3) extends through at least a portion of the body section 24 and at least a portion of the blade section 26. A peripheral wall 31 defines a face 33 that meets the blade section 26. The blade section 26 extends from the face 33. By way of a non-limiting example, the peripheral wall is generally cylindrical, however that need not be the case.

A body 32 is configured to be received by the knob 22. The body 32 can be, for example, a weight body configured to be received within at least a portion of the interior 30 of the knob 22. More specifically, the body 32 is received such that it is located in the body section 24 and the blade section 26 of the knob 22. The body 32 extends between a first end 34 and a second end 36. A first portion 38 of the body 32 at the first end 34 is shaped like a ring 40. The ring 40 is plate-like, however, that need not be the case. A second portion 42 of the body 32 extends from the ring 40 to the second end 36. The second portion 42 of the body 32 is forked. That is, the second portion 42 of the body 32 has a first side 44 and a second side 46 where at least a portion of the second side 46 is spaced from the first side 44. The second portion 42 of the body 32 is complimentary in shape to the interior surface 29 at the blade section 26 of the knob 22.

A spring 48 is configured to be received within the stem 28 of the knob 22. The spring 48 couples the stem 28 of the knob 22 to at least a portion of the control rod 15. In this manner, the knob 22 and the spring 48 are operably coupled to the control rod 15. The spring 48 is illustrated as a spring clip, but other suitable biasing members including springs or otherwise are contemplated.

A bezel 50 is configured to be operably coupled to the control panel 14 (FIG. 1). The bezel 50 is mounted to the control panel 14 in any suitable manner. By way of non-limiting example, the bezel 50 can be fixedly coupled to the control panel 14. By way of still further non-limiting examples this can include being mounted via tape, glue, screws, combinations thereof, or any other suitable fastening means. The bezel 50 is mounted such that it surrounds the control rod 15.

FIG. 3 shows the knob assembly 20 in an alternative exploded view so the interior 30 of the knob 22 and the first portion 38 of the body 32 can better be appreciated. As may be better seen, the stem 28 is at least partially located within the interior 30. The stem 28 extends past the body section 24 at a first end 51 of the knob 22. A passage 52 of the stem 28 has an opening 54 at a first end 56. A retainer 55 is defined by the passage 52. The retainer 55 is configured to receive the spring 48 and a portion of the control rod 15 via the opening 54. The retainer 55 is complimentary in shape to the spring 48. More specifically, the retainer 55 is D-shaped, however that need not be the case.

A set of protrusions 58 are located on the knob 22. More specifically, the set of protrusions 58 extend from an interior surface 29 of the face 33 of the knob 22. The set of protrusions 58 are configured to couple with the ring 40 of the body 32. While a total of four protrusions in the set of protrusions 58 are shown, any number of protrusions are contemplated including two, three, or five.

An interior opening 59 of the ring 40 is configured to receive the stem 28. A set of apertures 60 of the ring 40 are configured to receive or otherwise couple with the set of protrusions 58 of the knob 22. It is contemplated that the ring 40 can include apertures, protrusions, or a combination thereof. It is contemplated that the knob 22 can include the other of complimentary apertures, protrusions, or combination thereof such that the knob 22 can couple to the body 32. While a total of four apertures in the set of apertures 60 are shown, any number of apertures are contemplated including two, three, or five.

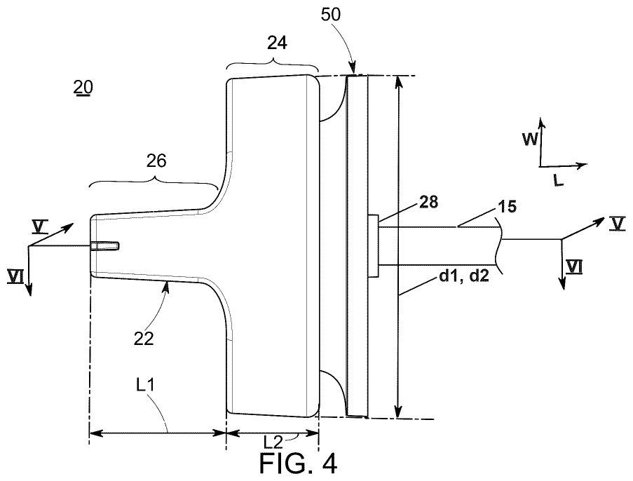

FIG. 4 is an enlarged side view of the assembled knob assembly 20 without the control panel 14 shown. When assembled, at least a portion of the bezel 50 is received in the body section 24 the knob 22. The bezel 50 is flush with the knob 22. Put another way, the bezel 50 has a first diameter d1 and the knob has a second diameter d2 measured in a direction W, the first diameter d1 is the same as the second diameter d2.

The blade section 26 has a blade length L1 measured in a direction L, and the body section 24 has a body length L2 measured in the direction L. The flush edge between the bezel 50 and the knob 22 provide for a more aesthetic look. A ratio between the blade length and the body length is equal to 1.46. This range is configured to provide a more ergonomic grip for a user.

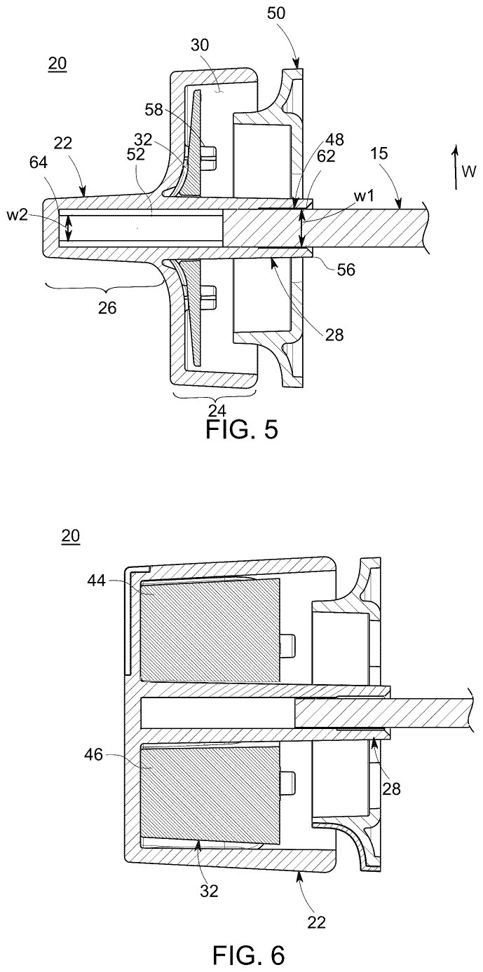

FIG. 5 is a cross-sectional view of the assembled knob assembly along line V-V of FIG. 4. A first end 62 of the passage 52 of the stem 28 has a first width w1 measured in the direction W. The stem 28 includes a second end 64, wherein the second end 64 is opposite to the first end 62. The second end 64 is located in the blade section 26 of the knob 22. The second end 64 has a second width w2 measured in the direction W. The second width w2 is smaller than the first width w1. That is, the passage 52 is larger at the first end 62 and smaller at the second end 64. The change in width acts as a stop for the spring 48 and the control rod 15 when they are received in the stem 28. The spring 48 fixes the control rod 15 to the stem 28 at the first end 62. The protrusions 58 of the knob 22 are received within the apertures 60 (FIG. 3) and the body 32 can optionally be glued, welded, fastened, or any combination thereof to the knob 22.

FIG. 6 is a cross-sectional view of the assembled knob assembly along line VI-VI of FIG. 4. FIGS. 5 and 6 better illustrate that the body 32 is received such that it is located in the body section 24 and the blade section 26 of the knob 22. The second portion 42 of the body 32 extends into the interior 30 of the blade section 26 of the knob 22. The first side 44 of the body 32 is located within the interior 30 of the blade section 26 on a first side of the stem 28 and the second side 46 of the body 32 is located within the interior 30 of the blade section 26 on a second side of the stem. The stem 28 is received within the interior opening 59 of the ring 40 (FIG. 3). Further still, the protrusions 58 of the knob 22 are received within the apertures 60 (FIG. 3). The ring 40 may abut the interior surface 29 of the face 33 (FIG. 2) although this need not be the case.

Referring to FIGS. 1-6 during assembly, by way of a non-limiting example, the knob 22 is coupled to the body 32. More specifically, the second portion 42 fits into blade section 26 of the knob 22. The set of protrusions 58 extend through or are otherwise coupled to the set of apertures 60 on the body 32 to fix the body 32 to the knob 22. The body 32 can further be fixed to the knob 22 via tape, welding, fastening via fastener, or any combination thereof. The spring 48 is inserted into the retainer 55 of the stem 28. The bezel 50 is fixedly mounted to the control panel 14 such that the bezel 50 surrounds the control rod 15. The knob 22 with the body 32 is coupled to the control rod 15 upon insertion of the control rod 15 into the stem 28. The spring 48 fixes the knob 22 with the body 32 to the control rod 15 such that the control rod 15 can be operably rotated by the knob 22. Once coupled to the control rod, a user can rotate the knob 22 to control the plurality of burners 18.

Aspects of the disclosure provide for several benefits including the knob assembly having a knob with blade to body ratio that improves the ergonomics of the knob. By improving the ergonomics of the knob, a user can more precisely turn or pivot the knob to correctly set the heating level for the plurality burners.

Additionally, the bezel being flush to the knob creates a more aesthetic look with may be mor pleasing to the user.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects of the disclosure are provided by the following clauses:

A knob assembly for a household appliance having a control panel and a control rod, the knob assembly comprising; a knob having a body section, a blade section, and a stem, and wherein the knob includes an exterior surface and an interior surface with the interior surface at least partially defining an interior extending through at least a portion of the body section and at least a portion of the blade section, a body received within at least a portion of the interior, a spring received within the stem, and a bezel configured to be operably coupled to the control panel and surrounding the control rod of the household appliance, wherein the knob and spring are operably coupled to the control rod.

The knob assembly of any preceding clause, wherein the stem is located within the interior.

The knob assembly of any preceding clause, wherein the stem extends past the body section.

The knob assembly of any preceding clause, wherein the stem comprises a passage having an opening at a first end and defining a retainer configured to receive the spring.

The knob assembly of any preceding clause, wherein the retainer is further configured to receive a portion of the control rod.

The knob assembly of any preceding clause, wherein the passage comprises a first width at the first end and a second width, smaller than the first width at an opposite end.

The knob assembly of any preceding clause, wherein the opposite end is located in the blade section.

The knob assembly of any preceding clause, wherein the body extends between a first end and a second end and wherein the body is received within the interior such that body is located in the body section and the blade section.

The knob assembly of any preceding clause, wherein the body includes a first portion at the first end and the first portion is shaped like a ring with an interior opening configured to receive the stem.

The knob assembly of any preceding clause, wherein the ring is plate-like.

The knob assembly of any preceding clause, wherein the ring comprises a set of apertures.

The knob assembly of any preceding clause, wherein a set of protrusions located on the knob extend through or otherwise couple to the set of apertures.

The knob assembly of any preceding clause, wherein the body includes a second portion extending from the ring to the second end.

The knob assembly of any preceding clause, wherein the second portion is forked.

The knob assembly of any preceding clause, wherein the second portion has a first side and a second side, spaced from the first side by the stem when assembled.

The knob assembly of any preceding clause, wherein the second portion is complimentary in shape to the interior surface at the blade section.

The knob assembly of any preceding clause, wherein a set of protrusions located on one of the knob or the body can couple to a set of apertures located on the other of the knob or body.

The knob assembly of any preceding clause, wherein the blade has a blade length and the body section has a body length, wherein a ratio between the blade length and the body length is equal to 1.46.

The knob assembly of any preceding clause, wherein the bezel is flush with the body section of the knob.

The knob assembly of any preceding clause, wherein the bezel is fixedly mounted to the control panel.

1. A knob assembly for a household appliance having a control panel and a control rod, the knob assembly comprising:
a knob having a body section, a blade section, and a stem, and wherein the knob includes an exterior surface and an interior surface with the interior surface at least partially defining an interior extending through at least a portion of the body section and at least a portion of the blade section;
a body received within at least a portion of the interior;
a spring received within the stem; and
a bezel configured to be operably coupled to the control panel and surrounding the control rod of the household appliance;
wherein the knob and spring are operably coupled to the control rod, and wherein the body extends between a first end and a second end and wherein the body is received within the interior such that the body is located in the body section and the blade section.

2. The knob assembly of claim 1, wherein the stem is located within the interior.

3. The knob assembly of claim 1, wherein the stem extends past the body section.

4. The knob assembly of claim 1, wherein the stem comprises a passage having an opening at a first end and defining a retainer configured to receive the spring.

5. The knob assembly of claim 4, wherein the retainer is further configured to receive a portion of the control rod.

6. The knob assembly of claim 4, wherein the passage comprises a first width at the first end and a second width, smaller than the first width at an opposite end.

7. The knob assembly of claim 6, wherein the opposite end is located in the blade section.

8. The knob assembly of claim 1, wherein the bezel is fixedly mounted to the control panel.

9. (canceled)

10. The knob assembly of claim 3, wherein the body extends between the first end and the second end, and wherein the body includes a first portion at the first end and the first portion is shaped like a ring with an interior opening configured to receive the stem.

11. (canceled)

12. The knob assembly of claim 10, wherein the ring comprises a set of apertures.

13. The knob assembly of claim 12, wherein a set of protrusions located on the knob extend through or otherwise couple to the set of apertures.

14. The knob assembly of claim 10, wherein the body includes a second portion extending from the ring to the second end.

15. The knob assembly of claim 14, wherein the second portion is forked.

16. The knob assembly of claim 15, wherein the second portion has a first side and a second side, spaced from the first side by the stem when assembled.

17. (canceled)

18. A knob assembly for a household appliance having a control panel and a control rod, the knob assembly comprising:
a knob having a body section, a blade section, and a stem, and wherein the knob includes an exterior surface and an interior surface with the interior surface at least partially defining an interior extending through at least a portion of the body section and at least a portion of the blade section;
a body received within at least a portion of the interior;
a spring received within the stem; and
a bezel configured to be operably coupled to the control panel and surrounding the control rod of the household appliance;
wherein the knob and spring are operably coupled to the control rod, and wherein a set of protrusions located on one of the knob or the body can couple to a set of apertures located on the other of the knob or body.

19. The knob assembly of claim 1, wherein the blade section has a blade length and the body section has a body length, wherein a ratio between the blade length and the body length is equal to 1.46.

20. The knob assembly of claim 1, wherein the bezel is flush with the body section of the knob.
